(19) United States
(12) Patent Application Publication
(10) Pub. No.: US 2021/0306292 A1
(43) Pub. Date: Sep. 30, 2021

(54) Opinion Matic Ideas

(71) Applicant: Levy Dervil, Tallahassee, FL (US)

(72) Inventor: Levy Dervil, Tallahassee, FL (US)

(21) Appl. No.: 16/828,946

(22) Filed: Mar. 24, 2020

(51) Int. Cl. H04L 12/58; G06F 16/9536

(52) U.S. Cl. CPC H04L 51/32; G06F 21/6254; G06F 16/9536

(57) ABSTRACT

The social media application is a platform intended to be a digital avenue for individuals to collaborate conversationally regarding global and local issues. The frame of operations distinguishing this concept is defined by a limited restraint and censorship approach in their capacity to express their ideas and viewpoints freely on the basis of the first amendment rights expressed in the American constitution. The social media application enables individuals to relinquish themselves of the societal pressures attached to projected identity expectations and social constraint with specific differentiating integrations separating identity from the transparent declaration of an individual viewpoint (109). The social media app is embedded with an original source algorithm to project and associate topics specific to the user account based on relevance to their search practices and interaction data.

### BACKGROUND

Various social media platforms have restrictions in place. These restrictions prevent people from exercising their first amendment rights fully, and integrate a degree of censorship as it relates to the digital projection of the individual voice. Platforms shy away from controversial topics, which prevent people from fully expressing their views and perspectives with total confidence in the digital avenues available to elicit total transparency of their expression. There is an intensely limited landscape of current digital platforms that enable individuals to genuinely speak their truth without fear of retaliation and censorship from the platform itself as well as from the pressures of social and cultural constraints. Freedom of speech has become sensitized and fragile. There needs to be a place where people can socialize with one another freely and fully without fear of attachment to social expectation and corporate revision.

### SUMMARY

A digital platform where you can freely exercise your first amendment right as related to speech. The platform is intended to provide and create a neutral space where one can engage in conversation concerning various subjects around the world, free of attachment to identity limitations, in order to provide free information & genuine daily feedback on different topics from an unfiltered global perspective. As the present disclosure relates, a free information, perspective projection platform proposed to facilitate free speech enablement via uncensored digital app avenue.

### BRIEF DESCRIPTION OF THE DRAWING

FIG. 1 is example screenshot of a display illustration of the app

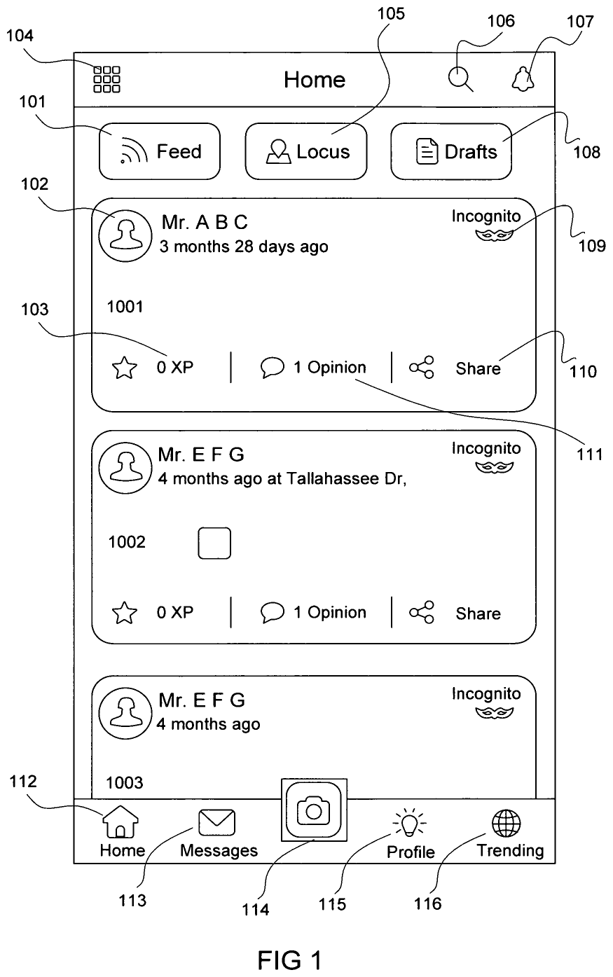

FIG. 2 a side view of the invention of FIG. 1

### DETAILED DESCRIPTION

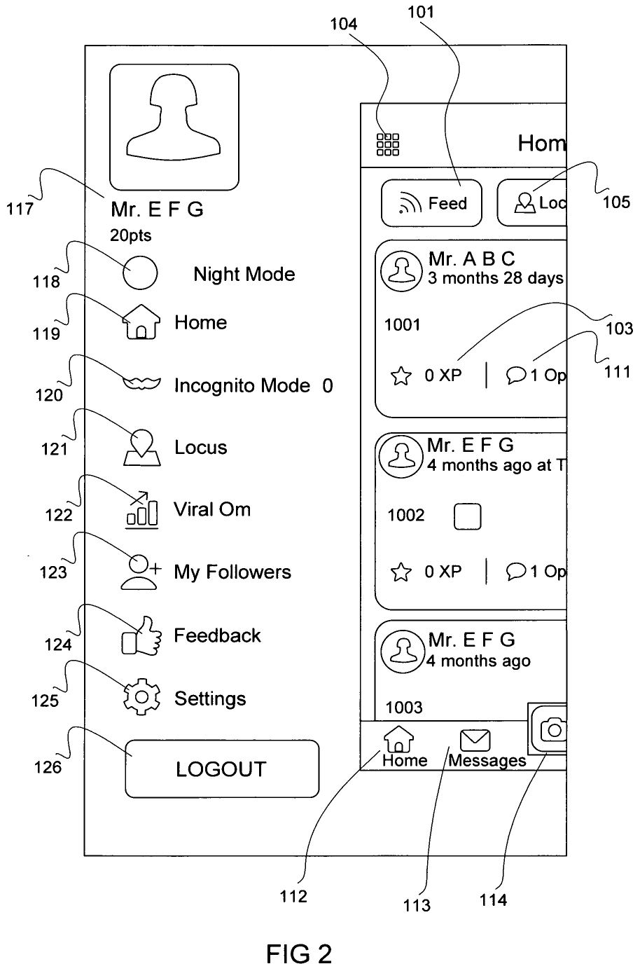

The purpose of the application is to provide a platform where you can speak your mind without fear of criticism or restraint. The present invention is described in enabling detail in the following examples, which may represent more than one embodiments of the present invention. 109 purpose is to hide the identity of the user, for example if the user posts, or comment on a topic it would be anonymous because the user may feel uncomfortable with revealing their true identity. FIG. 2 122 viral news feed sourced around the world Ranked based on international relevance & attention impact. 105 Where you can comment on local businesses, School nearby apartments and Etc. Also it has a GPS to guide you to your location of your choice. 116 purpose to allow users to input their opinions on popular topics while also interpreting the idea of their peers globally. Furthermore users can send their topics & the application will automatically pick one then post it on topic of the day so we can honor the user.

1: Users can input opinions on popular topics

2: The user of claim 1, can send their topics & the application will automatically pick one

3: Users can hide their identity when posting, or commenting on a topic it would be anonymous.
